(19) United States
(12) Patent Application Publication
(10) Pub. No.: US 2011/0232392 A1
(43) Pub. Date: Sep. 29, 2011

(54) Wireless Sensor for Measuring Mechanical Stress

(76) Inventor: Dieter Suess, Herzogenburg (AT)

(21) Appl. No.: 13/133,214

(22) PCT Filed: Nov. 16, 2009
(86) PCT No.: PCT/AT09/00438

§ 371 Date: Jun. 7, 2011

(30) Foreign Application Priority Data
Nov. 12, 2008 (AT) A 192/2008

(51) Int. Cl. G01B 7/16

(52) U.S. Cl. 73/779

(57) ABSTRACT

The invention relates to a sensor (2) for measuring mechanical stress acting thereon. The invention is characterized in that the sensor has an oscillating, magnetorestrictive resonator plate (3) and the stress to be measured acts on the resonator plate (3) indirectly by way of a variable magnetic field. The variable magnetic field is preferably created by way of a bias plate (5) made of magnetorestrictive material, or at least one permanent magnet (15) as a result of the mechanical stresses acting thereon by the body (7) to be measured.

### FIELD OF THE INVENTION

The invention relates to a method that allows to measure wireless mechanical stresses and pressures.

### BACKGROUND OF THE INVENTION

Sensors with magnetic cores are known for measuring stress such as in SE 9.5015, where the stress acting on a plate is measured. The stress on the plate changes the magnetic properties of a magnetostrictive core material of an electrical coil. The inductance of the coil is used to measure the stress state.

Other sensors with magnetostrictive material are disclosed in WO 2004/070408 A, JP2005338031 A, JP 8293012 A and U.S. 2002166382 A known.

The measurement of mechanical stress is important for a variety of applications such as structural health monitoring of bridges, roads, and other materials. Strain gages are the standard technique to measure mechanical stresses. Strain gages are usually glued or bonded to the object where the mechanical stress should be measured. The measured signal is the resistance of the strain gauge, which can be determined if an external voltage is applied. Therefore, the use of strain gages requires that they are wired. The same applies to piezoelectric sensors.

In many applications it is not possible to have cables connected permanently to the structure which is monitored, such as in buildings in public or where work is carried out. Hence, there is a need for sensors which are able to measure mechanical stresses contactless.

### DESCRIPTION OF THE INVENTION

The invention solves this problem and proposes to use an oscillating magnetostrictive ribbon (resonator) where the resonance frequency of the ribbon changes as a function of the external mechanical stress.

In the presented invention the mechanical stress is not directly mechanically applied to the magnetostrictive ribbon, but indirectly, via a magnetic field. The conversion of the mechanical stress into a stress dependent magnetic field can be realized for example by a further magnetostrictive ribbon, which is fixed (e.g. glued) to the body where the stress should be measured. Another possibility is to use one or more permanent magnets, which are arranged in a way so that they change its position as function of stress. In turn these magnets produce a field at the location of the resonator that depends on the stress.

Magnetostrictive ribbons are commonly used in electronic article surveillance systems (see Hearn, 2001). Recently, magnetostrictive ribbons have been investigated for the determination of temperature, pressure in fluids and for biological and chemical sensors, see Grimes 1999 and Zeng 2007. The measurement of fluid pressure relies on the change of damping of the magnetostrictive ribbon as a function of the fluid pressure. The change of the damping of the oscillations leads to a change of the resonance frequency.

For biological sensing the sensor is coated with a mass changing analyte-responsive layer that allows to monitor chemical concentrations including glucose, carbon dioxide, ethylene, ammonia.

The invention proposes to use wireless sensors based on magnetostrictive ribbons for the measurement of mechanical stresses. The sensor is a passive element that does not require a separate power supply or other electronic parts.

The substantial components of the sensor in the first embodiment are:

(i) A magnetic ribbon (resonator), which changes its resonance frequency as function of the applied magnetic;

(ii) A magnetic ribbon (transducer), which magnetization depends on the applied mechanical stress, and

(iii) a permanent magnet in order to adjust the operating point of the device.

The resonator consists of a magnetostrictive material that is placed in a protective cover so that the ribbon can freely mechanically vibrate.

A magnetostrictive element changes its geometric length as a function of the applied magnetic field. Thus, by applying a magnetic field pulse, the ribbon is elongated. The field pulse can be generated for example, with a transmitting coil which is positioned near the resonator. After switching off the field the resonator continuous to mechanical oscillate until the energy is dissipated and the original length is reestablished. The oscillation frequency of magnetic sensor characteristically depends on the applied magnetic field. Due to the magnetostrictive properties of the resonator a time varying magnetic field is emitted as long as the resonator mechanically oscillates. This magnetic field can be detected by a magnetic field sensor, such as a coil. The signal of the sensor can be received 1-2 m away from the magnetic field sensor.

The transducer can consist of a magnetostrictive material. The transducer is mechanically fixed (e.g. bonded or glued) to the object, where the stress should be monitored. If the object is deformed the length of the transducer is changed as well, which results in a change of the produced magnetic field. Consequently, this changes the resonant frequency of the resonator. This change of the resonance frequency can be used to determine the stress of the object the transducer is fixed to.

The permanent magnet is required to set the operating point of the sensor. Both the resonator and the transducer require a certain external field in order to have the desired functionality. The influence of the earth magnetic field can be compensated by using several sensors with different orientation or sensors. Another possibility to compensate for the earth magnetic field is to excite the sensor in one of its higher harmonic oscillations frequencies. This can be done e.g. by using as a permanent magnet, that has two region of the magnetization with antiparallel magnetization.

In another embodiment instead of a magnetoelastic material, one or more permanent magnets can be used as a transducer. As a function of stress the permanent magnets are displaced. For example the permanent magnets can be embodied in an elastic plastic matrix. Due to mechanical stress the relative positions of the magnetic elements are changed and therefore the field acting on the resonator is changed. Instead of such a bonded magnet one can also use one or more discrete permanent magnets, with a certain distance to the resonator. Due to the application of mechanical stress the position of the permanent magnets relative to the resonator changes, which in turn changes the resonance frequency of the system.

Thus, the invention discloses a wireless sensors for stress measurements. This is especially suitable for applications where cabling is impossible or leads to great effort and/or limitations in the application.

In the following we discuss in more details about the basic elements of the invention:

Resonator: It consists of a magnetostrictive material. It can be realized in the form of an amorphous ribbon. Alloys containing Fe, Co, Ni, Tb, Cu, Dy, Pd, B, P, C and Gd can be used. An other possibility is to use nanocrystalline materials, with grain sizes between 1 nm and 1 micron, containing Tb, Dy, Fe, Co, Ni, B, P, C, Gd, Si, B, Nb or Mo.

Permanent magnet: It is used to set the operating point. Possible materials are AINiCo magnets, alloys based on Fe-oxide, barium/strontium ferrites, compounds containing Sm, Ni, Co, Nd, Fe or B.

Transducer: The transducer consists of one or more magnets, which magnetization or strayfield changes as function of a mechanical stress. For example the transducer can be a magnetostrictive material. Due to the Villari effect which is the inverse effect of magnetostriction, the magnetization changes, if stress is applied. Another realization of the transducer is at least one permanent magnet, where the relative position of at least one permanent magnet with respect to the resonator changes as function of stress. It is also possible to use plastic bonded magnets, where the magnetic material is either magnetostrictive by itself or just flakes of hard magnets.

The term ribbon is used because of the obvious shape of these components, without the need to realize it in this form.

For the construction of the sensor it has been found essential that the stress indirectly applies to the resonator via a magnetic field. All attempts to directly transfer the mechanical stresses to the resonator, for example by clamping, proved to be unsuitable. This is due the fact that the resonator has to vibrate freely. Hence, the resonator has to be located in the sensor “free” or “loose” and should not be entirely glued, welded, etc.,

One possibility to clamp or glue the resonator is to fix it exactly at its center, since this does not disturb its free oscillation since the location of the center point does not change as a function of time.

### BRIEF SUMMARY OF THE INVENTION

The invention relates to a method that allows to measure wireless mechanical stresses and pressures. The mechanical stress is transferred to a stress dependent magnetic field by using of a transducer that can be a magnetostrictive element. This magnetic field acts on a resonator. The resonator is a magnetostrive ribbon that can be excited by an external magnetic field. The oscillation frequency of the oscillator is then directly related to the mechanical stress.

### BRIEF DESCRIPTION OF DRAWINGS

The foregoing discussion will be understood more readily from the following detailed description of the invention, when taken in conjunction with the accompanying drawings which show the following aspects:

FIG. 1: The invention of the sensor

FIG. 2: A detail of the sensor, with a compensation of the earth magnetic field

FIG. 3: A different perspective of the sensor of FIG. 2

FIG. 4: Sensor with permanent magnets as transducer

FIG. 5: Sensor with antennas

FIG. 6: Dependence of the resonance frequency as function of strain

FIG. 7: Sensor to measure mechanical forces

FIG. 8: Sensor to measure pressure

### DETAILED DESCRIPTION

The foregoing discussion will be understood more readily from the following detailed description of the invention, when taken in conjunction with the accompanying drawing, in which

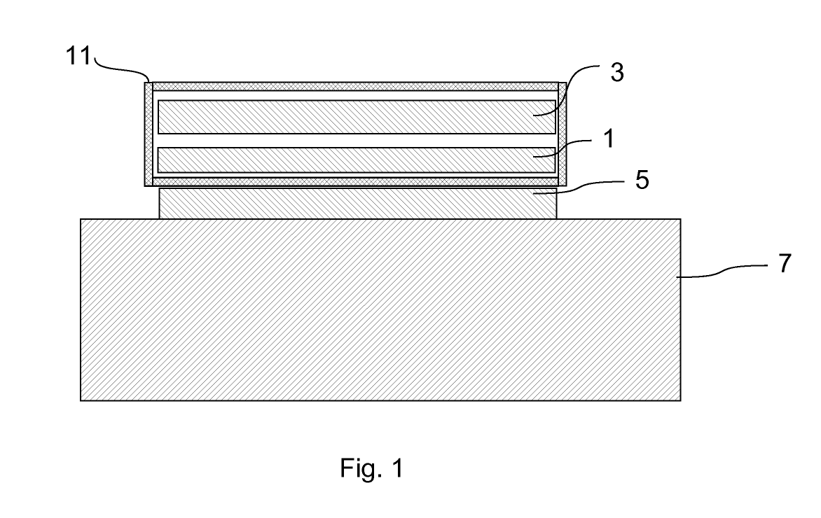

FIG. 1 shows in a case 11 a permanent magnet 1, which generates a static magnetic field which is important to set the working point of the sensor 2. Furthermore the figure shows the resonator 3, which is in this example a magnetostrictive ribbon. The resonance frequency of the resonator depends on the ambient conditions, such as temperature, pressure and external magnetic fields. In FIG. 1 the transducer (5) is again a magnetostrictive ribbon. The magnetization of the transducer is a function of the applied stress. The transducer is fixed (e.g. glued) to the object (7), where the stress should be measured. The connection between the different parts in not described in more detail, however the transducer should be properly fixed to the object, where the stress is measured. The resonator should be located in the case in a way that it can vibrate freely.

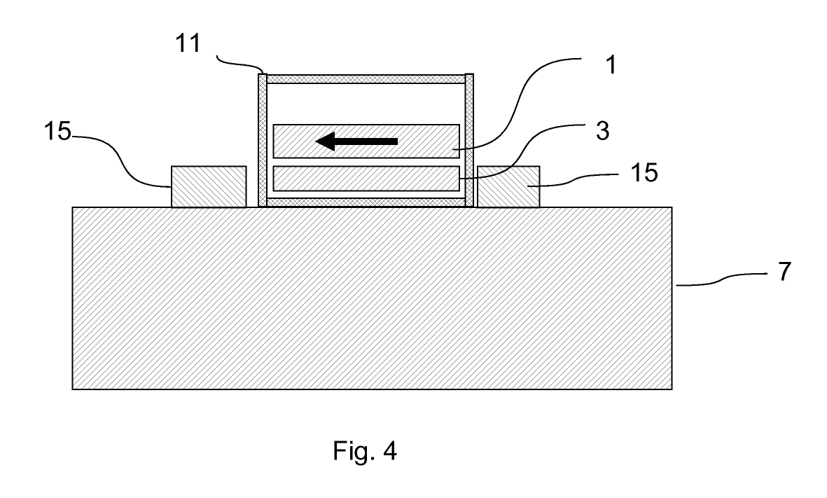

Instead of the use of magnetostrictive ribbons it is also possible to use permanent magnets (FIG. 4) as the transducer. Due to the stress applied on object (7) permanent magnets that are fixed to the object are displaced, which results in a change of the stray field at the position of the resonator.

The actual arrangement of the various ribbons may differ from that shown in FIG. 1 and FIG. 4. Thus, for example the ribbon 1 and ribbon 3 may be reversed. The protective covering 11, in which the sensor 2 is embedded may consist of a variety of materials, as long as neither the magnetic nor the mechanical oscillations are significantly distorted. Plastics such as thermoplastics, thermosets, elastomers are particularly preferred. In high temperature applications refractory ceramics such as compounds of silicate raw materials, compounds based on magnesite, silicon oxides, aluminum oxide, silicon carbide, boron nitride, zirconia, silicon nitride, aluminum nitride, tungsten carbide and aluminum titanate can be used.

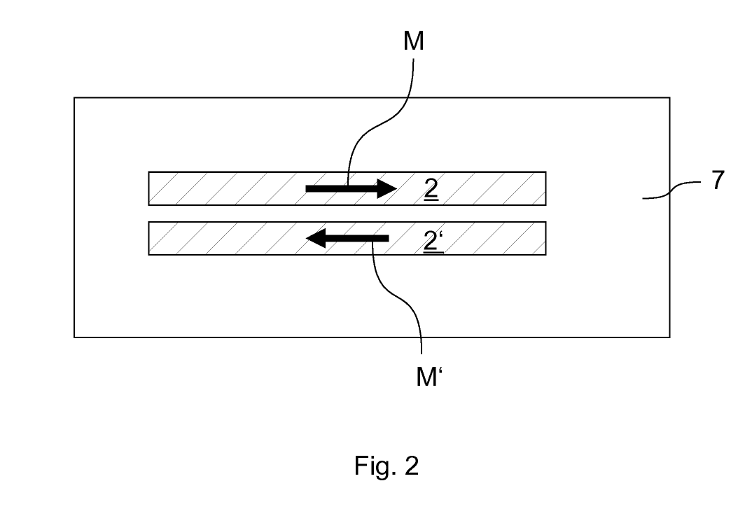

FIG. 2 shows, purely schematically, the possibility of using several magnetic sensors to compensate for external fields (earth's magnetic field) and the temperature. FIG. 2 shows a top view of two sensors with permanent magnets, whose average magnetization is substantially antiparallel, which is indicated by the arrows M. Thus, the earth magnetic field increases in one sensor element the resonance frequency, while it decreases the resonance frequency in the other sensor element. In order to be able to distinguish between the two sensor signals, resonators with different resonance frequencies can be used. This can be realized for example by a different length, different weights, different modulus, different-insoluble bias field, etc of the magnetostriktive ribbon.

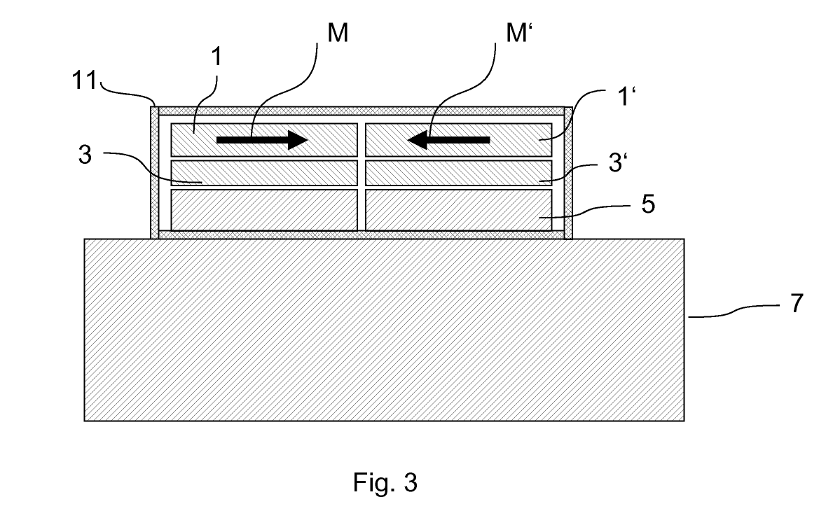

FIG. 3 shows a similar embodiment as in FIG. 2, but with a different arrangement of the individual components, such as magnetostrictive ribbon 5, permanent magnets 1 and resonator.

In the representation according to FIG. 4, the stress dependent stray field is generated by two permanent magnet 5. If the body where the stress is measured (7) is stretched, the distance between the permanent magnet 5 is increased. Consequently the magnetic field acting on the resonator changes. Optionally, an additional permanent magnet 1 can be used to set the operating point. The resonator 3 is located in the center.

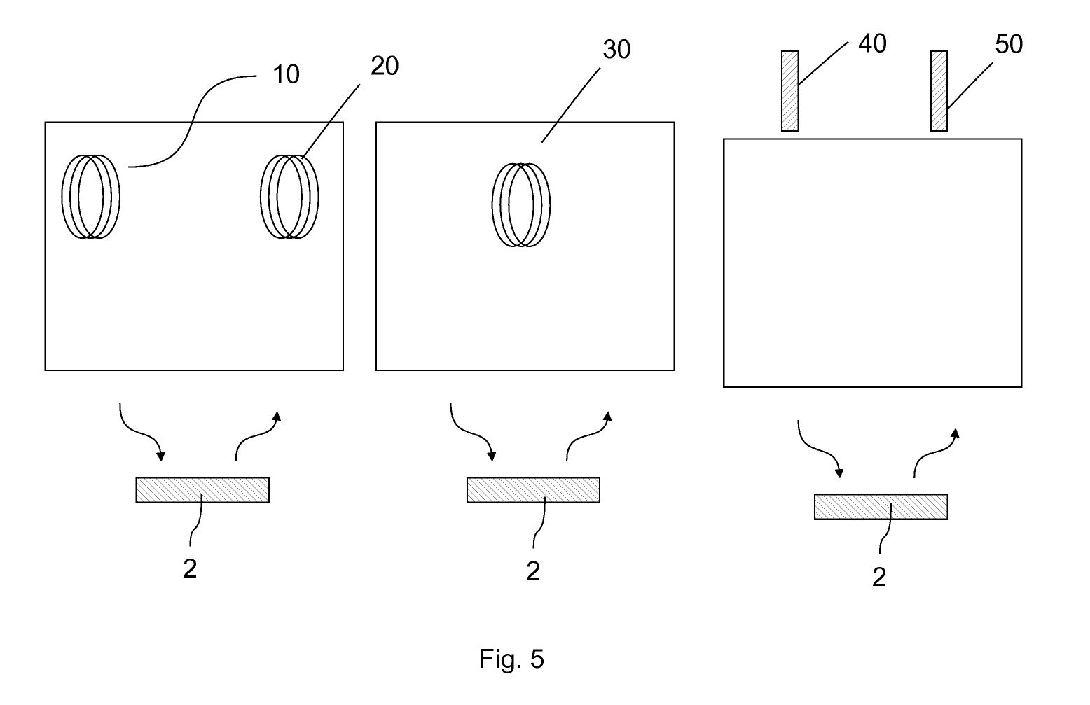

FIG. 5 shows some possible realization of the sensor and the signal detection. The transmitting antenna can be made by coils 10 which generate magnetic fields, as for example a static magnetic field which is switched on and off or alternating fields near the resonant frequency of the resonator. The excitation coil may have a magnetic core, a ferrite core, a soft, ferromagnetic core, etc. However, it also possible to use all other antennas 40, which have a resonance frequencies are between 5 kHz to 900 kHz.

The detection can occur via the excitation coil 30 or a separate receiving coil 20. The detection can also be done via Hall sensors, GMR sensors, TMR sensors, fluxgate sensors or ferrite antennas 50.

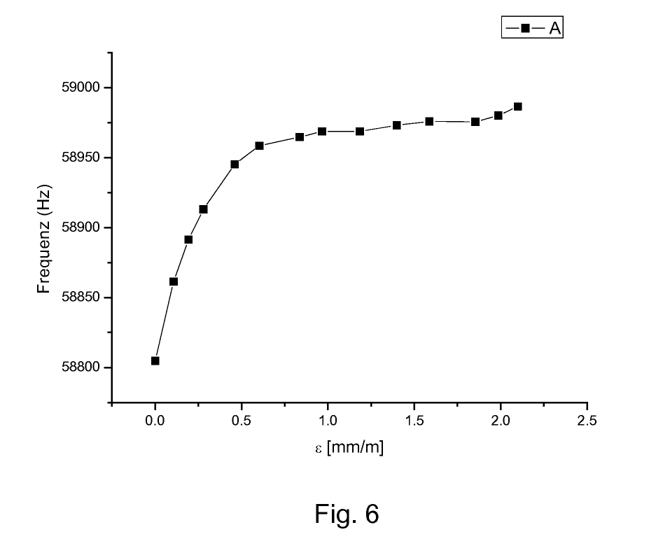

FIG. 6 shows a graph of the dependence of the resonance frequency (in Hz) of a prototype of the sensor as a function of strain [ ] (in mm/m). The length of the prototype sensor is about 50 mm. One can recognize the particularly good usable range up to a strain of about 0.5 mm/m. Above a strain of 0.5 mm/m the sensor is saturated. Suitable sensor designs can be used to transfer larger strains in the range, where a good linearity is given. Possible ways are to use plastic bonded magnets, where the magnetic particles are embedded in a plastic matrix.

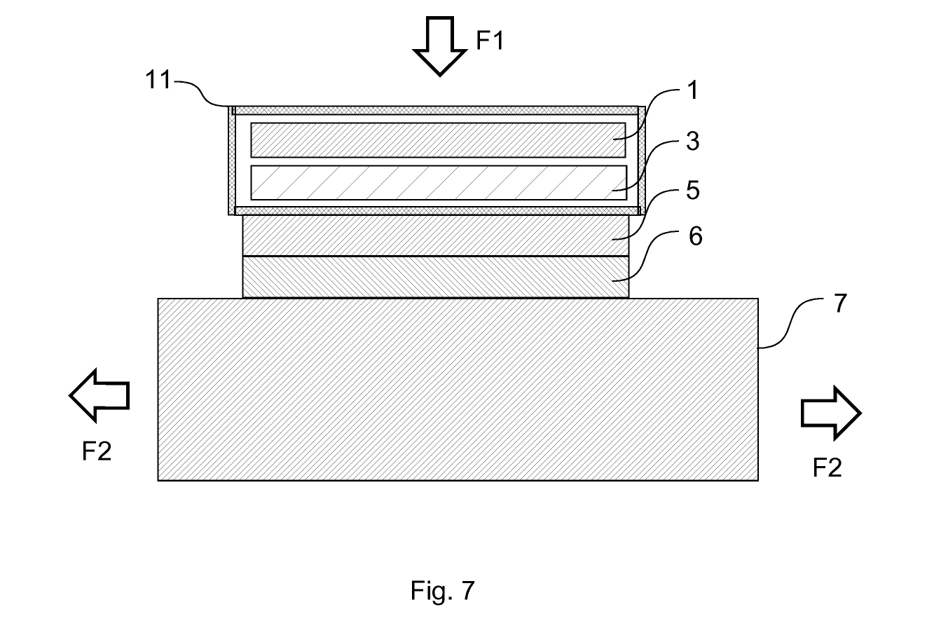

FIG. 7 shows a force sensor similar to the sensor of FIG. 1. An additional material 6 is used between the transducer and the object, where the stress state is measured. The additional material may be plastic or other material with high elasticity, eg elastomers or thermoplastics. This material has the task to deform due to a force F1. Due to the deformation of the additional element (6) the transducer 5 is deformed as well, resulting in a change of the strayfield acting on the resonator. With a suitable choice of the material, such as the thickness of material 6 and the E-moduls a wide variety of strengths of the force F1 can be measured.

The additional material (6) can also be used to transfer large strains of the object (7) due to forces F2 to strains which can be suitable measured with the sensor. In particular the additional material (6) can be used to transfer the strain into the linear region of FIG. 6.

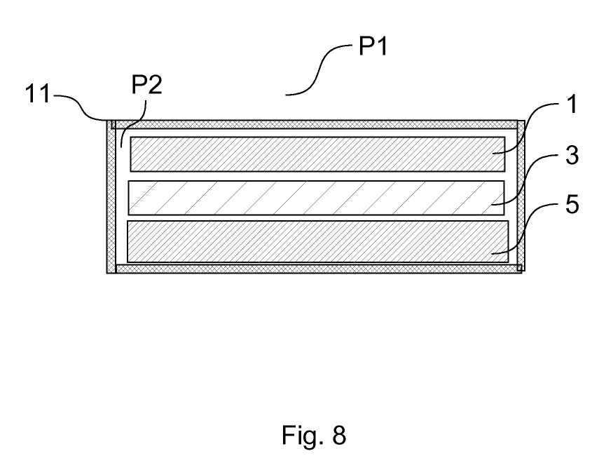

FIG. 8 shows a special design of the sensor as a gas pressure sensor. FIG. 8 shows an air-tight (waterproof) sealed capsule 11 with an internal pressure P2. A change in external air pressure P1 deforms the capsule. As a consequence the transducer (5) is deformed resulting in a change of the strayfield acting on the resonator. The resonator (3) can be placed freely in the capsule, or can be fixed on one or more points on the capsule. Such a sensor can be for example used to measure the air pressure in tires of vehicles (e.g trucks, cars). The transmitting and receiving antennas can be located for example in the wheel case.

For the sake of readability in the description and the claims it is refered to mechanical stress only. However, it is not restricted to stress, but strain and pressure can be measured as well.

The invention can be used to measure mechanical stress. The invention allows to map the stress to a mechanical resonant frequency, from which the stress and finally acting forces can be derived using the relationship as shown in FIG. 6.

The invention is not limited to the illustrated and described embodiments but can be modified in various ways. It is essential that the sensor does not require its own power supply and the required energy for the measurement process is transmitted without contact.

There are also different combinations of the elements possible or the usage of new materials is possible which are not explicitly shown.

The reason for this explicit statement is that particular in material sciences there is a rapid development which should not limit the claimed protection.

### LITERATURE

1. K. Zeng, C. Grimes, “Wireless Magnetoelastic Physical, Chemical, and Biological Sensors”, IEEE Trans Magn 43 (2007) 2358.

2. G. Herzer, “Der groβe Lauschangriff auf Ladendiebe”, Physikalische Blätter”, 57 (2001) 43.

3. C A Grimes, K G Ong, K. Loiselle, P G Stoyanov, Kouzoudis D, Liu Y, Tong C and F Tefiku, “Magnetoelastic sensors for remote query environmental monitoring”, Smart Mater. Struct. 8 (1999) 639-646.

1. Sensor (2) for the measurement of mechanical stress, comprises at least one magnetostrictive element with a distinct mechanical resonance frequency, wherein the stress is converted in a variable magnetic field acting on the magnetostrive element (3) using a transducer (5) comprising of a magnetostrive element by utilizing the inverse magnetoelastic effect—the Villari effect—, or at least a permanent magnet (15).

2. Sensor according to claim 1, wherein the variable magnetic field of the transducer (5) or of at least one permanent magnet (15) effects the magnetostrictive element (3).

3. Sensor according to claim 1, wherein the transducer (5) consists of a soft magnetic alloy, which has a coercive force smaller than 3000 A/m.

4. Sensor according to claim 1, wherein the change of the magnetic field due to stress is caused by a change of the saturation magnetization of the at least one permanent magnet (15).

5. Sensor according to claim 1, wherein the change of the magnetic field is caused by the change of the relative position of at least one permanent magnet with respect to the resonator.

6. A sensor according to previous claims, characterized that it comprises a permanent magnet (1) which sets the operating point of the sensor.

7. A sensor according to previous claims, characterized that the resonator (3) is loosely arranged in the housing of the sensor (11).

8. A sensor according to previous claims, characterized that the resonator (3) is fixed at one or more points to the housing (11).

9. A sensor according to previous claims, characterized that the sensor comprises a pressure-sealed capsule, which is deformed by a change of the external pressure, which in turn deforms the transducer (5).

10. A sensor according to previous claims, characterized that the transducer (5) is mounted to a body that is distorted by a variable external pressure in at least one spatial direction.

11. A sensor according to previous claims, characterized that the sensor can be used to determine the air pressure in the tires of vehicles.

12. A sensor according to previous claims, characterized that the transducer (5) or the at least one permanent magnet (15) is fixed to the body (7) where the mechanical stresses is measured.

13. A sensor according to previous claims, characterized that the transducer (5) or the at least one permanent magnet (15) is mounted to the object where the stress is measured via an intermediate material (6) having substantial different mechanical properties than the transducer.

14. Sensor (2) according to previous claims, characterized, that a second, sensor (2′) is arranged, preferably within a common envelope (11), having a permanent magnet (1′) with an average magnetization (M′), which is oriented at least substantially anti-parallel to the average magnetization (M) of the permanent magnet (1) of the first sensor.

15. Pair of sensors according to claim 13, characterized that the sensors (2, 2′) can be distinguished by using resonators (3, 3′) with different resonances, eg by different length, different weights, different modulus, different bias field.
